(19) United States
(12) Patent Application Publication
(10) Pub. No.: US 2026/0343715 A1
(43) Pub. Date: Oct. 29, 2026

(54) AUXILIARY LIGHTING SYSTEM WITH SOLIDSTATE HEADLIGHT DISCONNECT

(71) Applicant: 906 Engineering Corp., Marquette, MI (US)

(72) Inventors: Peter Carl Menze, Marquette, MI (US); Matthew Menze, Marquette, MI (US); Stephen Robert Lang, Ishpeming, MI (US)

(21) Appl. No.: 19/555,830

(22) Filed: Mar. 3, 2026

Related U.S. Application Data
(60) Provisional application No. 63/765,994, filed on Mar. 3, 2025.

(51) Int. Cl. H05B 47/17; B60Q 1/00; B60Q 1/14; B60Q 1/18; H05B 47/29

(52) U.S. Cl. CPC H05B 47/172; B60Q 1/0076; B60Q 1/1407; B60Q 1/18; H05B 47/29; B60Q 2800/20

(57) ABSTRACT

An auxiliary lighting system with solid state headlight disconnect to assure operation of a vehicle's OEM lights in the event of auxiliary lighting failure. The system comprising a set of OEM high beam lights, a set of OEM low beam lights, at least one auxiliary light, and with circuitry comprising at least a solid state first blocking element positioned between the low beam lights and a low beam input, and a solid state second blocking element positioned between the high beam lights and high beam input. An auxiliary input operable to receive power to illuminate the auxiliary light and power the first and second blocking element to open and cause consequent loss of power to the OEM lights. The blocking elements can be in the form of MOSFETs. The circuitry can include MOSFET protection and additional ground protection.

### CROSS REFERENCE TO RELATED APPLICATIONS

This application claims priority to Provisional Patent Application No. 63/765,994 filed Mar. 3, 2025, the entire disclosure of which is hereby incorporated by reference and relied upon.

### BACKGROUND OF THE INVENTION

Field of the Invention. The invention relates generally to auxiliary lighting systems, and more particularly to auxiliary lighting systems that complement standard lighting systems on motor vehicles.

Description of Related Art. Auxiliary lighting systems are commonly mounted on the front of vehicles or on add-on accessories such as a snowplow, sweeper, snow blower, or front loader. These add-on accessories often block the vehicle's OEM headlights and thus necessitate the use of the auxiliary lighting. Switching between the OEM headlights and auxiliary lighting systems is typically managed by the use of a double throw switch as depicted for example by the six pole two position switch 30 and toggle switch 31 of Miller's U.S. Pat. No. 4,280,062 in FIG. 1. In other cases, switching between the OEM headlights and auxiliary lighting systems is managed by the use of a double throw relay as depicted for example, by a first relay and second relay of Knepel's U.S. Pat. No. 5,420,480 as depicted in FIG. 2. A double throw relay is used to do its common, normally opened or normally closed contacts (spot relay). This type of relay is also used to switch between OEM headlights and auxiliary lights and is designed to default to the OEM headlights if there is a failure of the plow system or if the add-on accessory is removed. However, these relays are unreliable due to one or more of mechanical breakdown, contact arcing, back EMF interference, and corrosion problems. This can lead to serious injury if vehicle lighting goes dark during travel. FIG. 3 is another example of a switching circuit using a 12Volt relay 149, a coil 148 in the relay, a switch 147, load voltage positive 150, and load voltage ground 151.

What is needed is a robust and reliable switching system between a vehicle's OEM headlights and auxiliary lighting system to assure lighting will remain present for the driver even in the event of auxiliary lighting failure.

### SUMMARY OF THE INVENTION

Disclosed herein is an auxiliary lighting system with circuitry that solves the problems associated with the commonly used double throw switches or double throw relays that switch between OEM headlights and auxiliary lights.

In one form, an auxiliary lighting system comprises a solidstate OEM headlight disconnect circuit (OEM-HLD).

In one form, the OEM headlight disconnect circuit uses the OEM headlight's power source as a source of electrical power.

In one form, the OEM headlight disconnect circuit is solidstate and is fail safe unlike commonly used SPDT relays (single pole-double throw).

In one form, an OEM headlight disconnect circuit is absent mechanical relays.

In one form, the solidstate OEM headlight disconnect circuit is electrically controlled and powered by the OEM vehicle and is independent of outside interference.

In one form, the OEM headlight disconnect circuit responds to a failure in the auxiliary lighting by powering the vehicle's OEM headlights for safety.

In one form, the OEM headlight disconnect circuit can be used for all accessories on vehicles such as for example, turn signals and running lights.

In one form, the following benefits are realized from utilizing a solidstate OEM headlight disconnect circuit (OEM-HLD) as a replacement for prior systems: simplified manufacturing, improved reliability, reduced size requirements, and improved safety by reliably defaulting to the OEM headlights in the event of auxiliary lighting failure.

In one form, the OEM-HLD's default state is a closed circuit and will open to an open circuit upon receiving a signal.

In one form, the solidstate OEM-HLD uses the vehicle's OEM's high or low beam power feed and ground to default the OEM-HLD to a closed state.

In one form, a solidstate OEM-HLD uses additional circuitry not part of the vehicle's OEM headlight circuit to power its circuit to default to a closed state.

In one form, a solidstate OEM-HLD circuit utilizes a MOSFET with its gate controlled by the OEM's high or low beam feed to cause it to default to a closed state.

In one form, a solidstate OEM-HLD circuit utilizes a MOSFET to switch off power to the vehicle's OEM headlight feed that powers the OEM headlights.

In one form, a solidstate OEM-HLD circuit utilizes a high side or low side driver (a gate voltage booster) to disconnect the OEM's headlights and is controlled by the OEM input signal.

In one form, a solidstate OEM-HLD circuit utilizes MOSFETs in series or back-to-back to disconnect the OEM headlights in both directions.

In one form, a solidstate OEM-HLD circuit utilizes a control signal to disconnect the OEM headlights from its headlight feed that is optically isolated or includes other means of isolation.

In one form, a solidstate OEM-HLD circuit that uses back-to-back Zener diodes for gate protection.

In one form, a solidstate OEM-HLD circuit that uses a diode between the gate and source of MOSFETs in the circuit. This can be used for example to protect feedback from outside circuits on the OEM side.

In one form, a solidstate OEM-HLD circuit utilizes a MOSFET gate driver or a MOSFET to control the gate of a headlight disconnect MOSFET that used the OEM headlight circuitry for its power and signals that will default to a closed circuit and upon receiving a signal will open.

In one form, a solidstate OEM-HLD circuit is configured wherein the circuit for driving the gate of a headlight disconnect MOSFET can be powered and controlled by a circuit or source of power other than the OEM-HLD circuit.

In one form, a solidstate OEM-HLD circuit comprises a headlight disconnector that in its default state is a closed circuit and that upon receiving an input will open the circuit.

In one form, a solidstate OEM-HLD circuit uses only the OEM's headlights power source and signals to default to a closed state with no outside intervention.

In one form, a solidstate OEM-HLD circuit that is optically isolated.

In one form, a solidstate OEM-HLD circuit wherein the gate of the MOSFET is isolated from the headlight circuit.

In one form, a solidstate OEM-HLD circuit uses back-to-back Zener diodes or TVS (transient voltage suppressor) for gate protection.

In one form, a solidstate OEM-HLD circuit utilizes a diode between a gate and source of the MOSFET.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a perspective view of a Figure from a patent illustrating use of a double throw switch to switch between vehicle lighting;

FIG. 2 depicts a schematic view of a Figure from a patent illustrating use of a double throw relay to switch between vehicle lighting;

FIG. 3 depicts a schematic view of an electrical circuit switching circuit using a 12 volt relay;

FIG. 4 depicts a schematic view of a solidstate OEM headlight disconnect circuit;

FIG. 4a depicts a schematic view of a back-to-back MOSFET circuit for utilization in a solidstate OEM headlight disconnect circuit;

FIG. 5 depicts a schematic view of a solidstate OEM headlight disconnect circuit utilizing a solidstate optical isolator;

FIG. 6 depicts a schematic view of a solidstate OEM headlight disconnect circuit utilizing a photovoltaic MOSFET driver;

FIG. 7 depicts a schematic view of a headlight disconnect circuit utilizing an advanced FET driver.

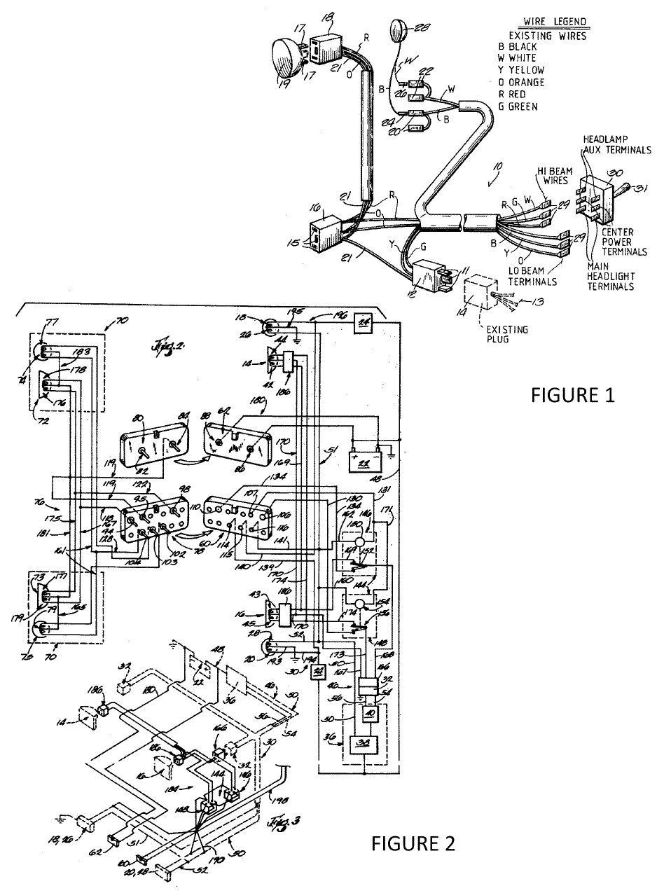

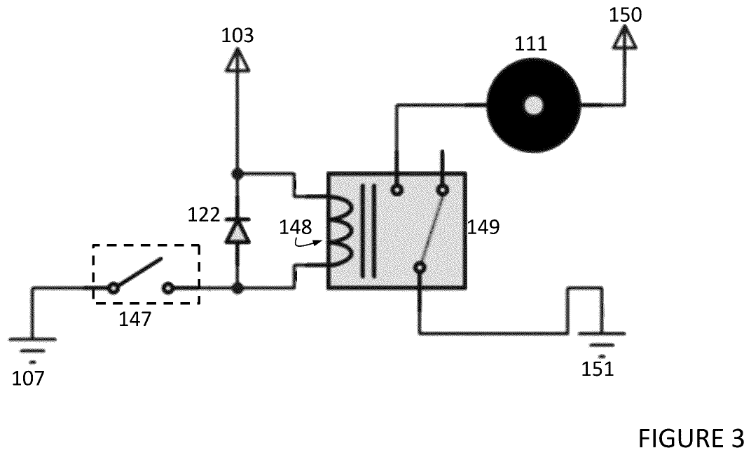

### DETAILED DESCRIPTION OF SELECTED EMBODIMENTS OF THE INVENTION

Select embodiments of the invention will now be described with reference to the Figures. Like numerals indicate like or corresponding elements throughout the several views. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

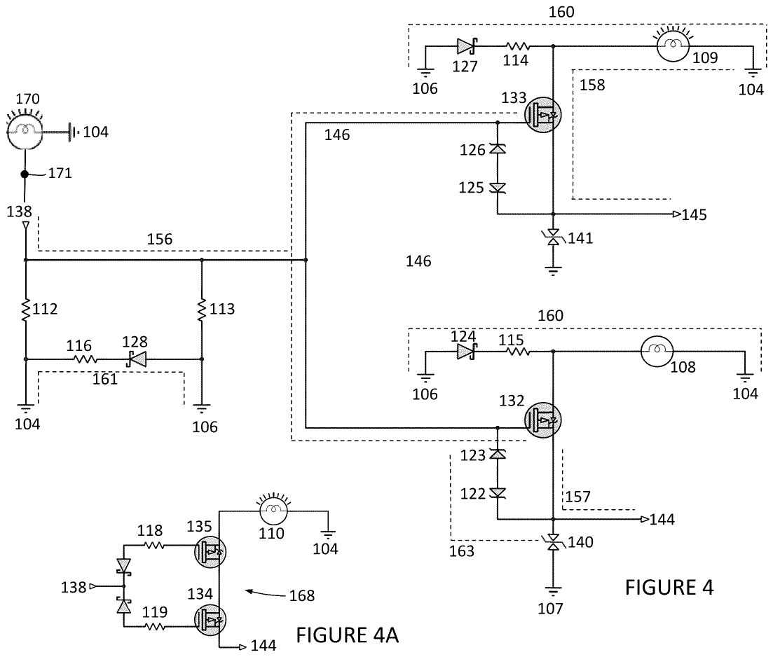

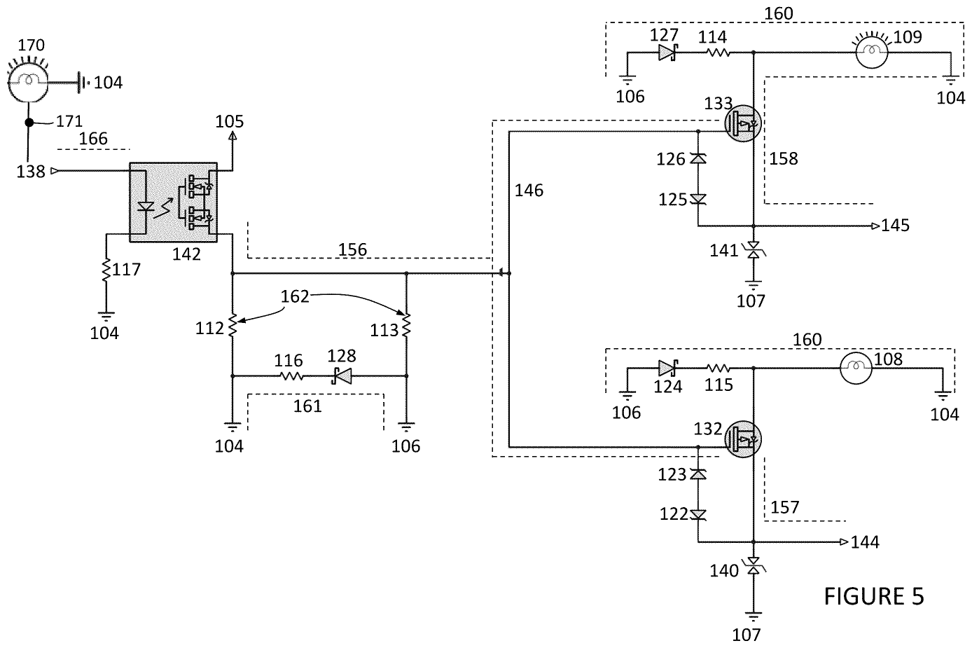

FIGS. 4-7 depict examples of solidstate OEM headlight disconnect circuitry (OEM-HLD) which solves the previously identified issues associated with prior art systems. As noted in each of these drawings, there is a low beam input 144 and a high beam input 145 which powers these lighting systems from the vehicle's headlight circuit. In other words, when the user activates the vehicle headlights from inside the vehicle, this power is directed to the solidstate OEM headlight disconnect circuit 100 at these points using the OEM headlight's high beam and low beam power as a source of electrical power. This power is then delivered by electrical conduit 146 such as wires to a first blocking element 132 for low beam lights (first light 108) and a second blocking element 133 for high beam lights (second light 109). These lights are typically in a paired set. The blocking elements can be in the form of a FET (field effect transistor) for example, which default to the closed position so that power flow can continue to the OEM vehicle's respective high beam lights and low beam lights. Therefore, the OEM headlight disconnect circuit is solidstate and is fail safe unlike those that use relays.

The solidstate OEM disconnect circuit 100 is therefore electrically controlled and powered by the OEM vehicle and is independent of outside interference. It can pull power from the headlight inputs, headlight outputs or both. It can also utilize grounds such as a 2_ground 106 to ground itself. It can respond to a failure in the auxiliary lighting by powering the vehicle's OEM headlight power feed for safety utilizing a MOSFET with its gate defaulting to a closed state assuring the OEM vehicle lights will illuminate. This occurs via the first blocking element 132 and second blocking element 133 defaulting to their closed positions because the OEM-HLD's default state is a closed circuit. In some embodiments, Activating an auxiliary light switch 171 in the vehicle can simultaneously send power to the blocking elements turning them off so that current cannot flow to the OEM headlights. In preferred embodiments, one or more MOSFETs are used to switch off power to the vehicle's OEM headlight feed that powers the OEM headlights.

Various embodiments of the solidstate OEM-HLD circuit 100 can utilize blocking elements in the form of MOSFETs in series, such as depicted in FIG. 4, or in a back-to-back configuration to disconnect the OEM headlights in both directions. For example, first blocking element 132 and/or second blocking element 133 can be replaced with the back-to-back MOSFET configuration 168 depicted in FIG. 4A. Note that back-to-back is the common used term but the MOSFETS can be arranged front-to-front, common-source configuration, common-drain configuration, and a P channel and N channel configuration. These orientations depend on control preferences for switching the load and will be understood by those skilled in the art. In some cases, a back-to-back MOSFET configuration is used to control voltage in both directions.

FIG. 4 represents a basic solidstate OEM-HLD circuit 100. Variations of this circuit can be utilized, and several variations are described later. Electrical components in these circuits include a vehicle ground 104 which is where a circuit is grounded to the vehicle such as at its frame. A vehicle positive 105 which is typically delivered from the positive terminal of the vehicle's battery. A 2_ground 106 which is an additional backup grounding site. The 2-ground and the vehicle ground can merge to provide ground to the solidstate OEM disconnect circuit 100 or to provide ground to MOSFET gates used within the circuitry. The 2-ground direction and protection can be facilitated by a diode or resistor or both.

Second ground path 160 is utilized to keep the MOSFET gate pulled to ground. Here, the blocking element is not blocking and the head light is on. D3, D6, R4, R3 are used in this second ground path 160 to prevent reverse battery and over load or short circuit problems.

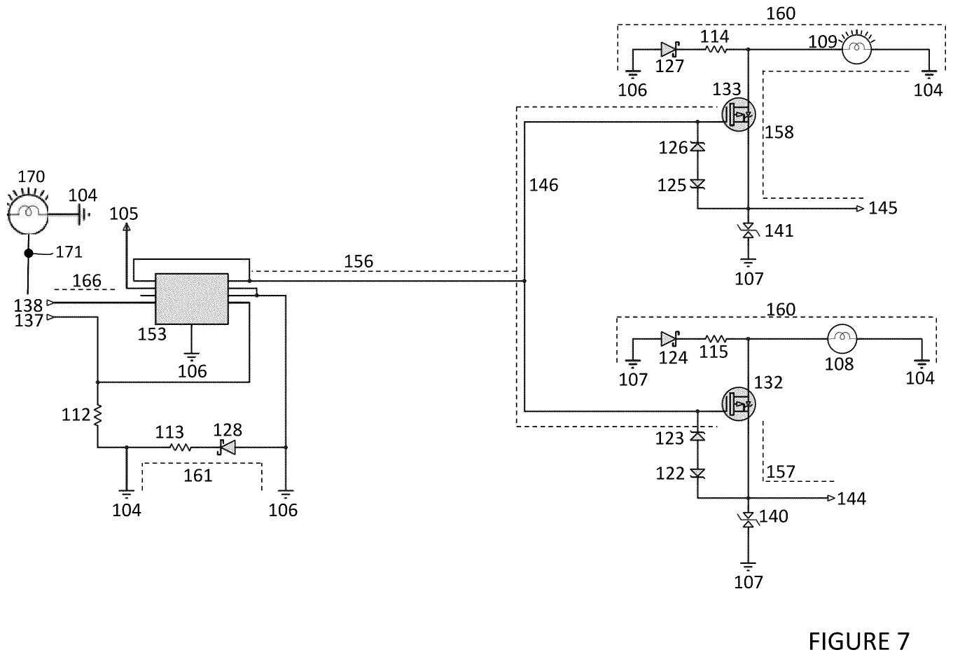

Ground 107 refers generically to a grounding site. A first light 108 (low beam headlights on vehicle) and second light 109 (high beam headlights on vehicle) refer to the vehicles paired OEM headlights. Auxiliary lights 170 are utilized, for example, when plowing snow typically because the vehicle's OEM head lights are blocked by the snowplow. A load 111, could be a variety of other electrical devices to be powered. With respect to the circuits depicted in the Figures, they can comprise one or more of the following components. A first resistor 112, a second resistor 113, a third resistor 114, a fourth resistor 115, a fifth resistor 116, a sixth resistor 117, a seventh resistor 118, an eighth resistor 119, a first diode 122, a second diode 123, a third diode 124, a fourth diode 125, a fifth diode 126, a sixth diode 127, a seventh diode 128, an eighth diode 129, and a nineth diode 130. Other blocking elements can be used such as a third blocking element 134 and a fourth blocking element 135 such as shown in the back-to-back MOSFET configuration 168. In addition, an undervoltage lockout 137 can be utilized as depicted in FIG. 7 with high speed MOSFET driver 153. Voltages to the high speed MOSFET driver can be lower and therefore not necessarily adequate to directly drive auxiliary lights 170 as depicted.

FIG. 5 depicts one embodiment a solidstate OEM-HLD circuit 100 having an optically isolated control signal used to disconnect the OEM headlights from its headlight feed. Note in the circuit is a solidstate optical isolator 142. An optical isolator is a LED and photosensitive transistor that transfers data using light across an isolation barrier such as an airgap. Since there is no physical connection between each side such as grounds or datalines, noise and power surges are removed consequently protecting the circuit from interference.

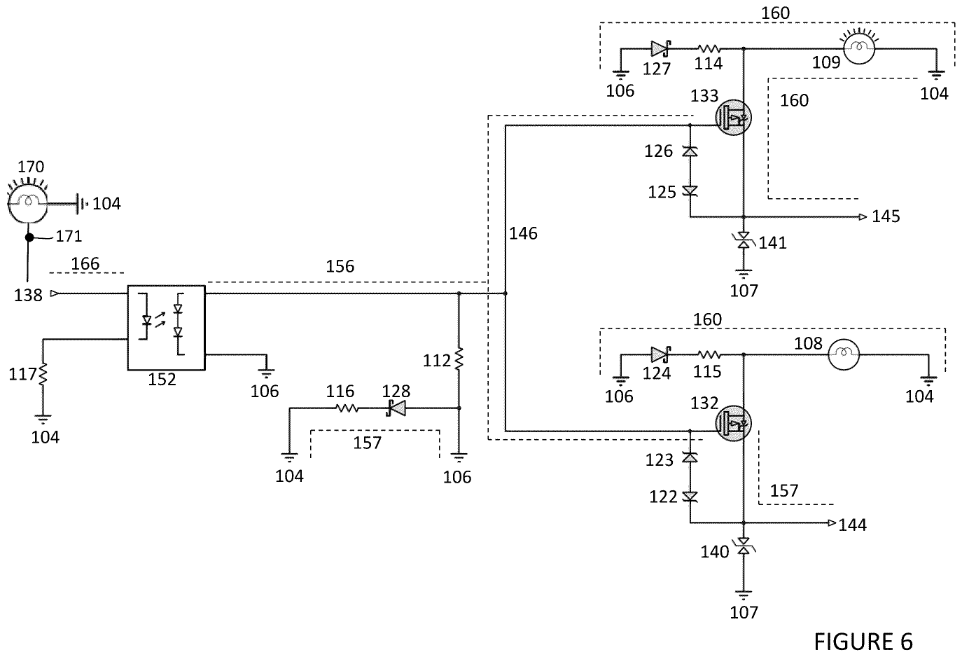

FIG. 6 depicts another embodiment of a solidstate OEM-HLD circuit much like the circuit in FIG. 5, yet using a photovoltaic MOSFET driver 152 to produce a control signal to disconnect the OEM headlights from its headlight feed. In other embodiments, such as depicted in FIG. 7, a high-speed MOSFET driver 153 is used to produce a control signal to disconnect the OEM headlights from its headlight feed. MOSFET drivers tend to offer a better, safer way to control MOSFETS.

Given these components of solidstate OEM-HLD circuits 100, circuit protection of the blocking elements can be included. For example, back-to-back Zener diodes can be utilized for gate protection. This is depicted as first diode 122 and second diode 123 for first blocking element 132 and fourth diode 125 and fifth diode 126 for second blocking element 133. A transient voltage suppressor (i.e. first transient voltage suppressor 140, second transient voltage suppressor 141) can also be used for gate protection. Again, a diode can be utilized between the gate and source of MOSFET used in the circuit to protect feedback from outside circuits on the OEM side circuitry.

In some embodiments, a solidstate OEM-HLD circuit 100 uses a MOSFET gate driver to control the gate of the headlight disconnect MOSFET that is used in the OEM headlight circuitry. Here, the MOSFET will default to a closed circuit and upon receiving a signal will open. In some embodiments, the MOSFETS are P-channel, whereas in other embodiments the MOSFETS are N-channel. For example, an N-channel MOSFET is likely to be used in a negatively switched vehicle. The function would be the same but the components would change to handle NEG powered headlights. The diodes would be reversed and MOSFETs changed to (N channel) etc. For positive+switching head lights, the headlight inputs are positive +and the respective headlight bulb is turned on by a positive feed and is grounded.

In one embodiment, when MOSFETs in the blocking elements turn off, the gate is pulled down towards ground and it turns itself off. The gate of the MOSFET is controlled in an ‘on’ state from the OEM side and it turns the respective MOSFET on. Auxiliary power 138 pulls this voltage to a level that turns the MOSFET's gate to off.

Common pathways depicted on FIGS. 4-7 are shown as follows. An auxiliary power path 156 extends from auxiliary power and extends to the blocking elements. In most cases, these pathways are in the form of wiring although other forms of conduit 146 known in the art can be used. OEM interrupted path 157 depicts the path when a blocking element (such as first blocking element 132) is engaged by a signal provided by the auxiliary power path 156 turning the MOSFET off and thus cut off from the respective OEM headlight. In this example, auxiliary power path 156 is positive+causing the related blocking element (i.e. first blocking element 132 and second blocking element 133) off and therefore cutting power to both the OEM low beam and high beam lights (first light 108, second light 109). In this case, the blocking elements are in the form of MOSFETs.

Note that in some of the Figures, one of the OEM head lights (first light 108, second light 109) are depicted with one set illuminated and the other set not. This is for depiction only. Second light 109 is depicted as illuminated, which is the case when the corresponding second blocking element 133 is closed, and first light 108 is depicted as non-illuminated which is the case when the corresponding first blocking element 132 is open and thus preventing the flow of power to the light. In true operation, both blocking elements are simultaneously powered to open the circuit or simultaneously not powered so both blocking elements are closed and thus allowing the flow of power to the respective high beams and/or low beam lights. With this in mind, OEM powered path 158 depicts the path power travels when the respective blocking element is closed (not blocking) and thereby illuminating the corresponding head light. A second ground path 160 is depicted in the drawings supporting grounding of the OEM high beam and low beam lights. A vehicle ground to 2_ground path 161 is also depicted for improved grounding and thus reliability of the circuitry. In some embodiments, gate pull down resistors 162 are used for further protection off the auxiliary power path keeping the gates of the MOSFETs low or grounded. Circuitry for MOSFET protection 163 can also be utilized. In this case, in the form of a voltage suppressor (i.e. first transient voltage suppressor 140, second transient voltage suppressor 141) and back-to-back Zener diodes. Blocking path 166 is the signal path from the plow or control to block the OEM headlights in some embodiments. Note the auxiliary lights 170 which can be used for example when plowing. Diodes in the system can be used (i.e. third diode 124, sixth diode 127) to prevent positive+to flow to the 2_ground thereby preventing a short. Note that these various pathways are not labeled a feature numbers on every Figure but are clearly present.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A solid state OEM headlight disconnect circuit on a vehicle comprising:
a high beam light;
a low beam light;
an auxiliary light;
a high beam input operable to receive power to illuminate said high beam light;
a low beam input operable to receive power to illuminate said low beam light;
a first solid state blocking element electrically positioned between said high beam light and said high beam input;
a second solid state blocking element electrically positioned between said low beam light and said low beam input;
an auxiliary input operable to receive power to illuminate said auxiliary light; and,
wherein power from said auxiliary input powers said first blocking element and said second blocking element to open with consequent loss of power to said high beam light and said low beam light.

2. The solid state OEM headlight disconnect circuit of claim 1 wherein said blocking element comprises a MOSFET.

3. The solid state OEM headlight disconnect circuit of claim 2 wherein the gate of said MOSFET is isolated from the vehicle's OEM headlight circuitry.

4. The solid state OEM headlight disconnect circuit of claim 2 wherein the gate of said MOSFET is pulled to ground to consequently turn itself off.

5. The solid state OEM headlight disconnect circuit of claim 1 wherein said blocking element comprises back-to-back MOSFETs.

6. The solid state OEM headlight disconnect circuit of claim 1 further comprising back-to-back MOSFETS to control voltage in both directions.

7. The solid state OEM headlight disconnect circuit of claim 1 wherein said blocking element further comprises MOSFET protection circuitry.

8. The solid state OEM headlight disconnect circuit of claim 1 wherein said auxiliary input further comprises a photovoltaic MOSFET driver.

9. The solid state OEM headlight disconnect circuit of claim 1 wherein said auxiliary input further comprises a high speed MOSFET driver.

10. The solid state OEM headlight disconnect circuit of claim 1 wherein said auxiliary input further comprises an optoisolator.

11. The solid state OEM headlight disconnect circuit of claim 1 wherein said blocking element is in the form of a P-channel MOSFET.

12. The solid state OEM headlight disconnect circuit of claim 1 wherein said blocking element is in the form of a N-channel MOSFET.

13. The solid state OEM headlight disconnect circuit of claim 1 wherein said blocking element defaults to a closed position assuring power delivery to the vehicles headlights in the event auxiliary power is lost.

14. The solid state OEM headlight disconnect circuit of claim 1 further comprising:
back to back Zener diodes; and
wherein said back to back Zener diodes are utilized for protection of at least one of said first and second blocking elements.

15. The solid state OEM headlight disconnect circuit of claim 1 further comprising:
a transient voltage suppressor.

16. The solid state OEM headlight disconnect circuit of claim 1 wherein the circuit for driving the gate of the blocking elements is controlled by a source of power separate from the OEM headlight circuit.

17. The solid state OEM headlight disconnect circuit of claim 1 further comprising a gate voltage booster.

18. The solid state OEM headlight disconnect circuit of claim 1 further comprising an optically isolated control signal operable to disconnect OEM headlights from their power source.

19. The solid state OEM headlight disconnect circuit of claim 1 further comprising a diode between a gate and source of said MOSFET.

20. The solid state OEM headlight disconnect circuit of claim 1 further comprising a ground from one or more of the OEM headlights inputs and outputs.
